(19) United States
(12) Patent Application Publication
(10) Pub. No.: US 2020/0035176 A1
(43) Pub. Date: Jan. 30, 2020

(54) LIQUID CRYSTAL DISPLAY DEVICE AND DRIVE METHOD FOR SAME

(71) Applicant: SHARP KABUSHIKI KAISHA, Osaka (JP)

(72) Inventor: KOHICHI OHHARA, Osaka (JP)

(21) Appl. No.: 16/506,323

(22) Filed: Jul. 9, 2019

Related U.S. Application Data
(60) Provisional application No. 62/703,082, filed on Jul. 25, 2018.

(51) Int. Cl. G09G 3/36

(52) U.S. Cl. CPC G09G 3/3648; G09G 3/3674; G09G 2320/0271; G09G 2310/08; G09G 2320/0626; G09G 3/3685

(57) ABSTRACT

In a liquid crystal display device performing an overdrive drive of a liquid crystal panel and an impulse drive of a backlight, the liquid crystal panel includes an overdrive unnecessary area including pixels of which gradations converge to target levels before a backlight turn-on period when an arbitrary video signal is written to the pixels, and an overdrive necessary area including remaining pixels. An overdrive processing circuit includes a previous frame memory for storing an input video signal of less than one frame, including the input video signal with respect to the pixels in the overdrive necessary area, and a processing section for performing a correction for emphasizing a temporal change of a gradation, at least on the input video signal with respect to the pixels in the overdrive necessary area. With this, a capacity of a frame memory for storing a video signal of a previous frame is reduced.

### CROSS-REFERENCE TO RELATED APPLICATION

This application claims the benefit of U.S. Provisional Patent Application No. 62/703,082 filed on Jul. 25, 2018, and entitled “Liquid Crystal Display Device And Drive Method For Same”, which is incorporated herein by reference in its entirety.

### BACKGROUND OF THE INVENTION

### Field of the Invention

The present invention relates to a liquid crystal display device, and especially relates to a liquid crystal display device performing an overdrive drive and an impulse drive.

### Description of Related Art

A liquid crystal display device is widely used as a thin, light-weight, and low power consumption display device. A typical liquid crystal display device includes a liquid crystal panel, a backlight, a panel drive circuit, and a backlight drive circuit.

In order to improve a response speed of the liquid crystal panel, some liquid crystal display devices perform an overdrive drive of the liquid crystal panel. In the liquid crystal display device performing the overdrive drive, the liquid crystal panel is driven using a corrected video signal by emphasizing a temporal change of a gradation. Furthermore, in order to improve a moving picture display performance, some liquid crystal display devices perform an impulse drive of the backlight. In the liquid crystal display device performing the impulse drive, the backlight is driven so as to turn on in a backlight turn-on period in one frame period. In the following, a liquid crystal display device performing the overdrive drive of the liquid crystal panel and the impulse drive of the backlight is considered. Note that the overdrive drive is also called an overshoot drive and the impulse drive is also called a pseudo impulse drive.

As a prior art, Japanese Laid-Open Patent Publication No. 2010-271343 describes a liquid crystal display device that divides a display screen into two areas, compresses a video signal corresponding to one area with a low compression rate, compresses the video signal corresponding to another area with a high compression ratio, stores the compressed video signal as a video signal of a previous frame, and performs the overdrive drive.

In the overdrive drive, the corrected video signal is obtained based on a video signal of a current frame and a video signal of a previous frame. Thus, a frame memory for storing the video signal of the previous frame is necessary for the liquid crystal display device performing the overdrive drive. Therefore, the liquid crystal display device performing the overdrive drive and having many pixels has a problem that a capacity of the frame memory for storing the video signal of the previous frame increases and a cost of the device increases.

According to the liquid crystal display device described in Japanese Laid-Open Patent Publication No. 2010-271343, the capacity of the frame memory for storing the video signal of the previous frame can be reduced. However, this liquid crystal display device has a problem that an image quality of a display image deteriorates because the compressed video signal is stored.

### SUMMARY OF THE INVENTION

Therefore, providing a liquid crystal display device capable of reducing a capacity of a frame memory for storing a video signal of a previous frame without deteriorating an image quality of a display image is taken as a problem.

(1) A liquid crystal display device according to some embodiments of the present invention includes: a liquid crystal panel including pixels; a backlight; an overdrive processing circuit configured to obtain a corrected video signal by performing, on an input video signal, a correction for emphasizing a temporal change of a gradation; a panel drive circuit configured to write the corrected video signal to the pixels in a predetermined order; and a backlight drive circuit configured to control the backlight to turn on in a backlight turn-on period in one frame period, the liquid crystal panel has an overdrive unnecessary area including the pixels of which gradations converge to target levels before the backlight turn-on period when an arbitrary video signal is written to the pixels, and an overdrive necessary area including remaining pixels, and the overdrive processing circuit includes: a previous frame memory configured to store the input video signal of less than one frame, including the input video signal with respect to the pixels in the overdrive necessary area; and a processing section configured to perform the correction at least on the input video signal with respect to the pixels in the overdrive necessary area.

(2) The liquid crystal display device according to some embodiments of the present invention has the configuration of above (1), and the overdrive processing circuit is configured to perform, on the input video signal with respect to the pixels in the overdrive necessary area, the correction for bringing the gradations of the pixels to the target levels in the backlight turn-on period when the corrected video signal is written to the pixels.

(3) The liquid crystal display device according to some embodiments of the present invention has the configuration of above (2), and the overdrive processing circuit is configured to perform the correction for further emphasizing the temporal change of the gradation, as time from writing to the pixel to the backlight turn-on period is shorter.

(4) The liquid crystal display device according to some embodiments of the present invention has the configuration of above (3), the overdrive processing circuit includes a plurality of look-up tables, and the processing section is configured to perform the correction by selecting two look-up tables from the plurality of look-up tables in accordance with the time, obtaining two gradation values using the two look-up tables, and performing an interpolation operation on the two gradation values.

(5) The liquid crystal display device according to some embodiments of the present invention has the configuration of above (4), the look-up table is configured to store gradation values corresponding to combinations of representative gradation values of a video signal of a current frame and representative gradation values of a video signal of a previous frame, and the processing section is configured to, when obtaining the gradation value using the look-up table, read from the look-up table a plurality of gradation values in accordance with a gradation value of a current frame included in the input video signal and a gradation value of a previous frame included in the video signal stored in the previous frame memory, and perform an interpolation operation on the plurality of gradation values.

(6) The liquid crystal display device according to some embodiments of the present invention has the configuration of above (2), and the previous frame memory is configured to store only the input video signal with respect to the pixels in the overdrive necessary area.

(7) The liquid crystal display device according to some embodiments of the present invention has the configuration of above (2), and the previous frame memory is configured to store the input video signal with respect to the pixels in the overdrive necessary area and a part of the pixels in the overdrive unnecessary area.

(8) The liquid crystal display device according to some embodiments of the present invention has the configuration of above (7), and the processing section is configured to perform the correction only on the input video signal with respect to the pixels in the overdrive necessary area.

(9) The liquid crystal display device according to some embodiments of the present invention has the configuration of above (7), and the processing section is configured to perform the correction on the input video signal with respect to the pixels in the overdrive necessary area and a part of the pixels in the overdrive unnecessary area.

(10) The liquid crystal display device according to some embodiments of the present invention has the configuration of above (2), and the overdrive processing circuit further includes a current frame memory configured to store the input video signal.

(11) A drive method of a liquid crystal display device according to some embodiments of the present invention is a drive method of a liquid crystal display device having a liquid crystal panel including pixels and a backlight, the method includes: obtaining a corrected video signal in an overdrive processing circuit by performing, on an input video signal, a correction for emphasizing a temporal change of a gradation; writing the corrected video signal to the pixels in a predetermined order; and controlling the backlight to turn on in a backlight turn-on period in one frame period, the liquid crystal panel has an overdrive unnecessary area including the pixels of which gradations converge to target levels before the backlight turn-on period when an arbitrary video signal is written to the pixels, and an overdrive necessary area including remaining pixels, the overdrive processing circuit includes a previous frame memory that stores the input video signal of less than one frame, including the input video signal with respect to the pixels in the overdrive necessary area, and in obtaining the corrected video signal, the correction is performed at least on the input video signal with respect to the pixels in the overdrive necessary area.

In the above liquid crystal display device and the drive method for same, the previous frame memory storing the input video signal of less than one frame is used, and the input video signal with respect to at least a part of the pixels in the overdrive unnecessary area is not stored in the previous frame memory. Furthermore, even if the input video signal is not corrected, gradations of the pixels in the overdrive unnecessary area converge to the target levels before the backlight turn-on period. Therefore, in the liquid crystal display device performing the overdrive drive and the impulse drive, a capacity of a frame memory storing the video signal of the previous frame can be reduced without deteriorating an image quality of a display image.

These and other objects, features, modes and effects of the present invention will be more apparent from the following detailed description with reference to the attached drawings.

### BRIEF DESCRIPTION OF THE DRAWINGS

FIG. 1 is a block diagram showing a configuration of a liquid crystal display device according to an embodiment.

FIG. 2 is a diagram showing an area division of a liquid crystal panel of the liquid crystal display device shown in FIG. 1.

FIG. 3 is a block diagram showing a configuration of a signal processing circuit of the liquid crystal display device shown in FIG. 1.

FIG. 4 is a diagram showing a configuration of look-up tables of the liquid crystal display device shown in FIG. 1.

FIG. 5 is a flowchart showing an operation of a processing section of the liquid crystal display device shown in FIG. 1.

FIG. 6 is a diagram for explaining linear interpolation operations by the processing section of the liquid crystal display device shown in FIG. 1.

FIG. 7 is a timing chart of the liquid crystal display device shown in FIG. 1.

FIG. 8 is a diagram showing a relationship between the area division of the liquid crystal panel and a previous frame memory in the liquid crystal display device shown in FIG. 1.

FIG. 9 is a diagram showing a relationship between an area division of a liquid crystal panel and a previous frame memory in a liquid crystal display device according to a modification.

### DETAILED DESCRIPTION OF THE INVENTION

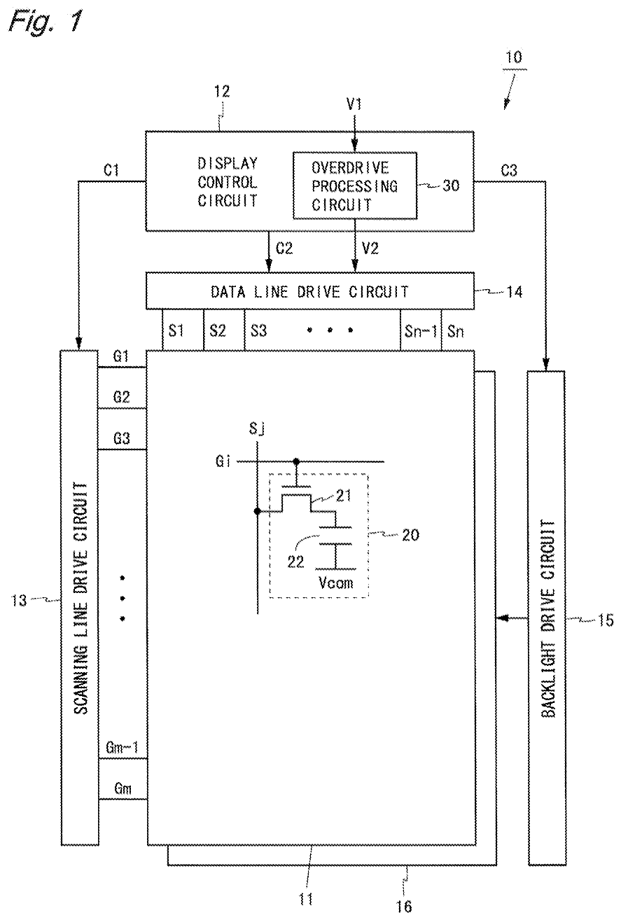

FIG. 1 is a block diagram showing a configuration of a liquid crystal display device according to an embodiment. A liquid crystal display device 10 shown in FIG. 1 includes a liquid crystal panel 11, a display control circuit 12, a scanning line drive circuit 13, a data line drive circuit 14, a backlight drive circuit 15, and a backlight 16. Hereinafter, m and n are integers not smaller than 2, i is an integer not smaller than i and not larger than m, and j is an integer not smaller than 1 and not larger than n.

The liquid crystal panel 11 includes m scanning lines G1 to Gm, n data lines S1 to Sn, and (m×n) pixels 20. The scanning lines G1 to Gm are arranged in parallel with each other. The data lines S1 to Sn are arranged in parallel with each other so as to intersect with the scanning lines G1 to Gm perpendicularly. The scanning lines G1 to Gm and the data lines S1 to Sn intersect at (m×n) points. The (m×n) pixels 20 are arranged corresponding to intersections of the scanning lines G1 to Gm and the data lines S1 to Sn.

The pixel 20 includes a thin film transistor (hereinafter referred to as TFT) 21 and a liquid crystal capacitance 22. In the pixel 20 in an i-th row and a j-th column, a gate terminal of the TFT 21 is connected to a scanning line Gi, and one conduction terminal (left-side terminal in FIG. 1) of the TFT 21 is connected to a data line Sj. Another conduction terminal of the TFT 21 is connected to one electrode (upper electrode in FIG. 1) of the liquid crystal capacitance 22. A common electrode voltage Vcom is applied to another conduction terminal of the liquid crystal capacitance 22 using means not shown. Note that the pixel 20 may include an auxiliary capacitance in parallel with the liquid crystal capacitance 22.

The display control circuit 12 includes an overdrive processing circuit 30. The overdrive processing circuit 30 obtains a corrected video signal V2 by performing, on an input video signal V1 input from an outside of the liquid crystal display device 10, a correction (overdrive processing) for emphasizing a temporal change of a gradation. The display control circuit 12 outputs a control signal C1 to the scanning line drive circuit 13, outputs a control signal C2 and the corrected video signal V2 to the data line drive circuit 14, and outputs a control signal C3 to the backlight drive circuit 15.

The scanning line drive circuit 13 drives the scanning lines G1 to Gm based on the control signal C1. More specifically, in the liquid crystal display device 10, one frame period includes m horizontal periods and a retrace period. The retrace period is set after the m horizontal periods. The scanning line drive circuit 13 selects the scanning lines G1 to Gm in an ascending order in the m horizontal periods. The scanning line drive circuit 13 applies a voltage with which the TFT 21 turns on, to the selected scanning line in each horizontal period. With this, n pixels 20 connected to the selected scanning line are selected collectively.

The data line drive circuit 14 drives the data lines S1 to Sn based on the control signal C2 and the corrected video signal V2. More specifically, the data line drive circuit 14 respectively applies n voltages (hereinafter referred to as data voltages) in accordance with the corrected video signal V2, to the data lines S1 to Sn in each horizontal period. With this, the n data voltages are respectively written to the selected n pixels 20. Transmittance of the pixel 20 changes in accordance with a written data voltage. The scanning line drive circuit 13 and the data line drive circuit 14 function as a panel drive circuit for writing the corrected video signal V2 to the pixels 20 in a predetermined order.

The backlight 16 is arranged on a back side of the liquid crystal panel 11, and irradiates a back surface of the liquid crystal panel 11 with light. The backlight drive circuit 15 drives the backlight 16 based on the control signal C3. More specifically, in the liquid crystal display device 10, a backlight turn-on period is set in the retrace period. The backlight drive circuit 15 controls the backlight 16 to turn on with a predetermined brightness in the backlight turn-on period, and controls the backlight 16 to turn off otherwise. With this, the backlight 16 is impulse driven. The backlight drive circuit 15 controls the backlight 16 to turn on in the backlight turn-on period in one frame period.

When a video signal (specifically, data voltage in accordance with the video signal) is written to the pixel 20, transmittance of the pixel 20 changes toward a level (hereinafter referred to as a target level) in accordance with the written video signal. However, it takes some time for the transmittance of the pixel 20 to converge to the target level. Thus, the transmittance of the pixel 20 may continue changing even in the backlight turn-on period. In general, in a liquid crystal display device performing the impulse drive, a gradation of a pixel (brightness of the pixel) becomes a level obtained by averaging a product of brightness of a backlight and transmittance of the pixel in the backlight turn-on period. In the liquid crystal display device 10, since brightness of the backlight 16 is constant in the backlight turn-on period, the gradation of the pixel 20 changes as with the transmittance of the pixel 20.

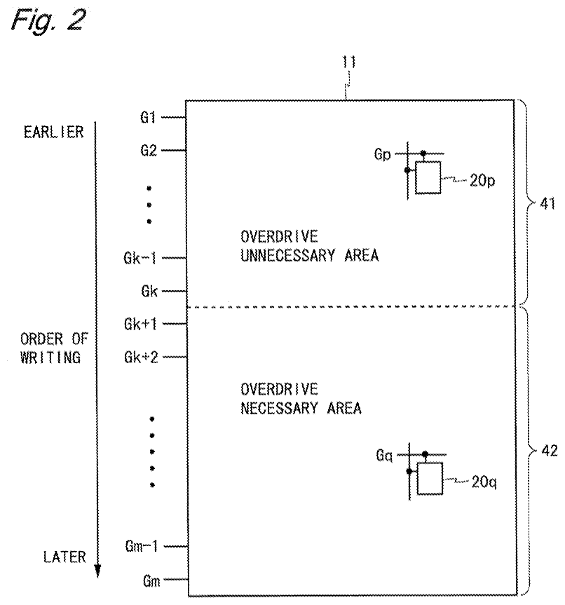

FIG. 2 is a diagram showing an area division of the liquid crystal panel 11. In FIG. 2, the scanning lines Gi to Gm are arranged from top to bottom of the liquid crystal panel 11 in an ascending order, and a selection order of the scanning lines G1 to Gm (writing order to the pixels 20) is an order from top to bottom of the liquid crystal panel 11. The liquid crystal panel 11 has an overdrive unnecessary area 41 and an overdrive necessary area 42. The overdrive unnecessary area 41 is an area including the pixels 20 of which gradations converge to the target levels before the backlight turn-on period when an arbitrary video signal (including a video signal on which the overdrive processing is not performed) is written to the pixels. The overdrive necessary area 42 is an area including remaining pixels 20.

Hereinafter, k is an integer larger than 1 and smaller than m, p is integer not smaller than 1 and not larger than k, and q is an integer larger than k and not larger than m. Furthermore, the overdrive unnecessary area 41 includes the pixels 20 in first to k-th rows, and the overdrive necessary area 42 includes the pixels 20 in (k+1)-th to m-th rows. As shown in FIG. 2, a pixel 20p in a p-th row is included in the overdrive unnecessary area 41, and a pixel 20q in a q-th row is included in the overdrive necessary area 42.

In one frame period, the data voltage is written to the pixels 20 in the overdrive unnecessary area 41, before the data voltage is written to the pixels 20 in the overdrive necessary area 42. For example, the data voltage is written to the pixel 20p in the p-th row, before the data voltage is written to the pixel 20q in the q-th row. A gradation of the pixel 20p in the p-th row starts to change earlier than a gradation of the pixel 20q in the q-th row. The gradation of the pixel 20p in the p-th row converges to the target level before the backlight turn-on period, even when the input video signal V1 on which the overdrive processing is not performed is written. Thus, the overdrive processing circuit 30 does not perform the overdrive processing on the input video signal V1 with respect to the pixel 20p in the p-th row. In contrast, in order to bring the gradation of the pixel 20q in the q-th row to the target level in the backlight turn-on period, the overdrive processing circuit 30 performs the overdrive processing on the input video signal V1 with respect to the pixel 20q in the q-th row.

In order to store a video signal of a previous frame, a conventional liquid crystal display device performing the overdrive drive has a previous frame memory capable of storing the video signal of at least one frame. In contrast, in order to store the video signal of the previous frame, the overdrive processing circuit 30 according to the present embodiment has the previous frame memory for storing the input video signal V1 with respect to the pixels 20 in the overdrive necessary area 42. A capacity of the previous frame memory is less than one frame of the input video signal V1. The previous frame memory stores the input video signal V1 with respect to the pixels 20 in the overdrive necessary area 42, and does not store the input video signal V1 with respect to the pixels in the overdrive unnecessary area 41. However, as described later, the previous frame memory may store the input video signal V1 with respect to a part of the pixels 20 in the overdrive unnecessary area 41.

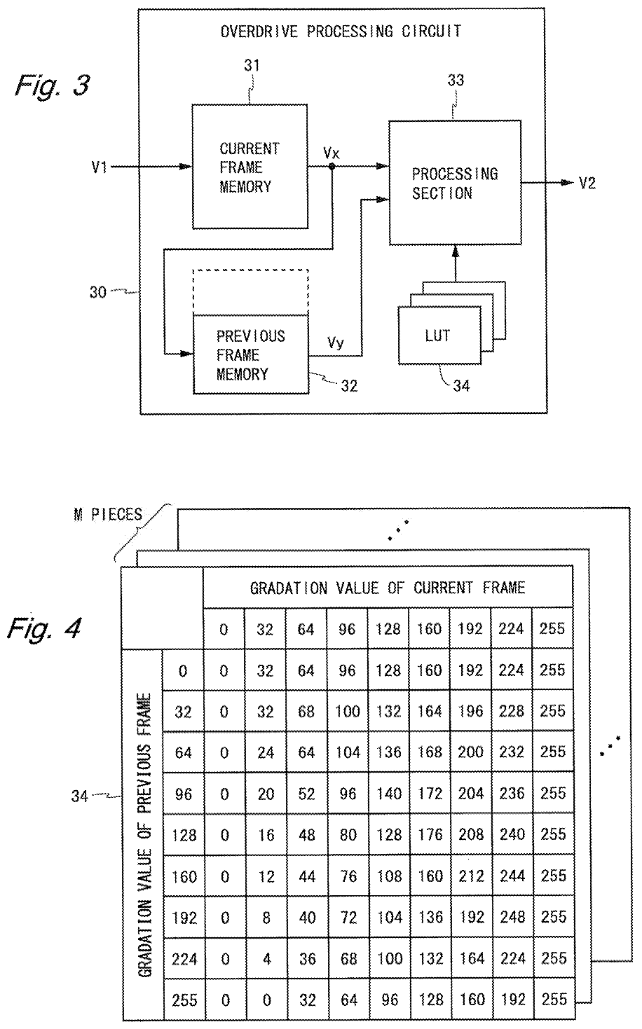

FIG. 3 is a block diagram showing a configuration of the overdrive processing circuit 30. The overdrive processing circuit 30 shown in FIG. 3 includes a current frame memory 31, a previous frame memory 32, a processing section 33, and a plurality of look-up tables (hereinafter referred to as LUTs) 34. In the following, the number of the LUTs 34 included in the overdrive processing circuit 30 is M (M is an integer not smaller than 2 and not larger than (m−k)).

The input video signal V is input to the overdrive processing circuit 30. The current frame memory 31 has a capacity capable of storing the input video signal V1 of one frame. The current frame memory 31 stores the input video signal V1, and outputs the stored video signal after a predetermined time as a video signal. Vx of a current frame. The previous frame memory 32 has a capacity capable of storing the input video signal V1 of less than one frame, including the input video signal V1 with respect to the pixels 20 in the overdrive necessary area 42. The previous frame memory 32 stores the video signal with respect to the pixels 20 in the overdrive necessary area 42 out of the video signal Vx of the current frame output from the current frame memory 31, and outputs the stored video signal as a video signal Vy of a previous frame after one frame period. A broken line described in FIG. 3 indicates that the capacity of the previous frame memory 32 is less than one frame of the input video signal V1.

The input video signal V1 with respect to the pixels 20 in the overdrive necessary area 42 is stored in the previous frame memory 32. As for the pixels 20 in the overdrive necessary area 42, the processing section 33 obtains the corrected video signal V2 based on the video signal Vx of the current frame output from the current frame memory 31 and the video signal Vy of the previous frame output from the previous frame memory 32. On the other hand, the input video signal V1 with respect to the pixels 20 in the overdrive unnecessary area 41 is not stored in the previous frame memory 32. As for the pixels 20 in the overdrive unnecessary area 41, the processing section 33 outputs the video signal Vx of the current frame output from the current frame memory 31 as the corrected video signal V2 as it is.

In the following, a pixel corresponding to the pixel 20 in the i-th row and the j-th column is denoted by Pij, a gradation value of the pixel Pij included in the video signal. Vx of the current frame (gradation value of current frame) is denoted by Dx, a gradation value of the pixel Pij included in the video signal Vy of the previous frame (gradation value of previous frame) is denoted by Dy, and a gradation value of the pixel Pij included in the corrected video signal V2 (corrected gradation value) is denoted by Dz. A row number of the pixel Pij is i. As the row number i is larger, time from writing to the pixel 20 to the backlight turn-on period is shorter. The pixel Pij is included in the overdrive unnecessary area 41 when i≤k, and is included in the overdrive necessary area 42 when i>k.

The processing section 33 performs processing in accordance with the row number i (in other words, time from writing to the pixel 20 to the backlight turn-on period). When i≤k, the previous frame memory 32 does not store the gradation value Dy of the previous frame, and the gradation value Dy of the previous frame is not output from the previous frame memory 32. In this case, the processing section 33 outputs the gradation value Dx of the current frame as the corrected gradation value Dz as it is.

When i>k, the previous frame memory 32 stores the gradation value Dy of the previous frame, and the gradation value Dy of the previous frame is output from the previous frame memory 32. In this case, the processing section 33 selects two LUTs from the M LUTs 34 in accordance with the row number i, and reads four gradation values from each of the selected LUTs 34, based on the gradation value Dx of the current frame and the gradation value Dy of the previous frame. The processing section 33 obtains two gradation values by performing a linear interpolation operation on the four gradation values read from each LUT 34, and obtains the corrected gradation value Dz by performing a linear interpolation operation on the two gradation values.

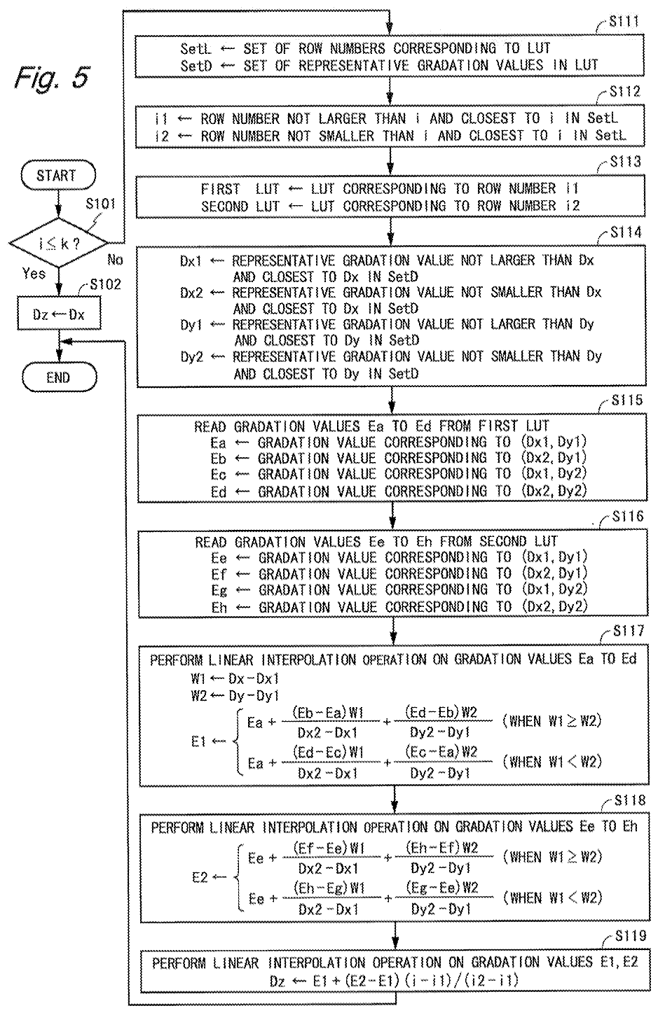

FIG. 4 is a diagram showing a configuration of the LUT 34. The M LUTs 34 are respectively corresponded to one of the (k+1)-th to m-th rows of the liquid crystal panel 11. Each LUT 34 stores corrected gradation values so as to emphasize a change, corresponding to combinations of N representative gradation values (N is an integer not smaller than 2 and not larger than a maximum gradation value) of the video signal Vz of the current frame and N representative gradation values of the video signal Vy of the previous frame. The LUT 34 corresponding to the i-th row of the liquid crystal panel 11 stores the gradation values with respect to the pixels 20 in the i-th row. As a corresponding row number i is larger, the LUT 34 stores corrected gradation values so that the change is further emphasized. By using such LUTs 34, the overdrive processing circuit 30 performs the correction for further emphasizing the temporal change of the gradation, as the time from writing to the pixel 20 to the backlight turn-on period is shorter.

Here, it is assumed that the gradation value of the pixel included in the input video signal V1 is an integer not smaller than 0 and not larger than 255, and the representative gradation values are 0, 32, 64, 96, 128, 160, 192, 224, and 255, nine values in total. Each LUT 34 stores 81 gradation values in total corresponding to combinations of nine representative gradation values of the video signal Vx of the current frame and nine representative gradation values of the video signal. Vy of the previous frame.

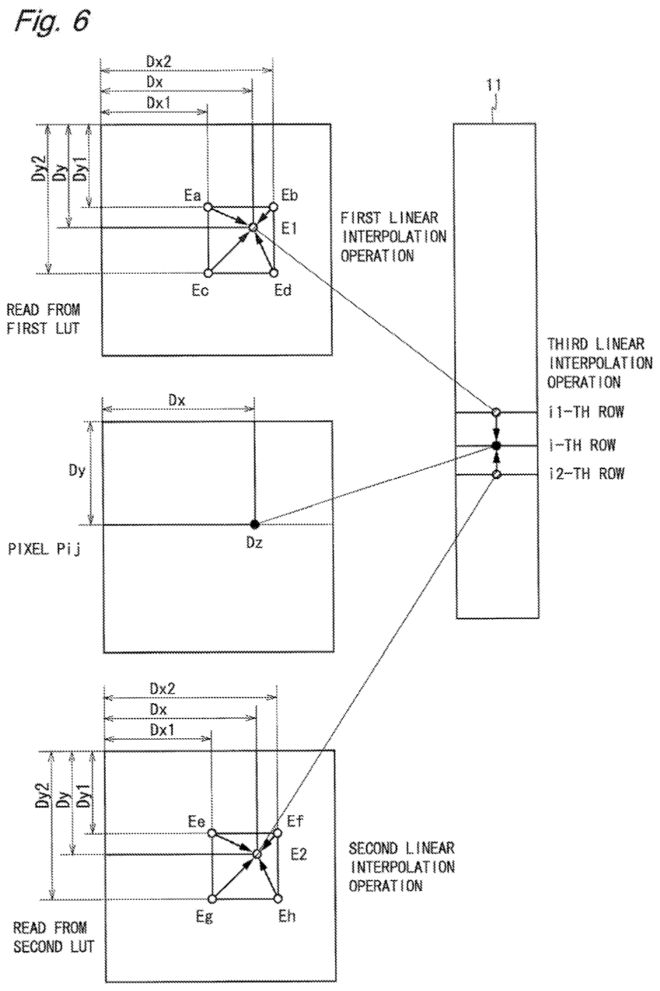

FIG. 5 is a flowchart showing an operation of the processing section 33. FIG. 6 is a diagram for explaining linear interpolation operations by the processing section 33. With reference to FIGS. 5 and 6, an overdrive processing related to the pixel Pij in the i-th row and the j-th column will be described.

As shown in FIG. 5, the processing section 33 first judges whether the row number i of the pixel Pij is equal to or smaller than k (step S101). The processing section 33 goes to step S102 if Yes, and goes to step S111 if No. In the former case, the processing section 33 sets the gradation value Dx of the current frame to the corrected gradation value Dz (step S102), and ends the processing.

In the latter case, the processing section 33 takes a set of row numbers corresponding to the LUT 34 as SetL, and takes a set of the representative gradation values in the LUT 34 as SetD (step S111). The set SetL includes M row numbers, and the set SetD includes N representative gradation values. Next, the processing section 33 obtains, from the set SetL of the row numbers, a row number i1 which is not larger than i and is closest to i, and a row number 12 which is not smaller than i and is closest to i (step S112). However, when the when the set SetL does not include row numbers smaller than i, the row number i1 is same as the row number i2, and when the set SetL does not include row numbers larger than i, the row number i2 is same as the row number i1. Next, the processing section 33 selects the LUT 34 corresponding to the row number i1 as a first LUT, and selects the LUT 34 corresponding to the row number i2 as a second LUT (step S113).

Next, the processing section 33 obtains, from the SetD of the representative gradation values, a gradation value Dx1 which is not larger than Dx and is closest to Dx, a gradation value Dx2 which is not smaller than Dx and is closest to Dx, a gradation value Dy1 which is not larger than Dy and is closest to Dy, and a gradation value Dy2 which is not smaller than Dy and is closest to Dy (step S114).

Next, the processing section 33 reads four gradation values from the first LUT selected in step S113 (step S115). More specifically, the processing section 33 reads, from the first LUT, a gradation value Ea when a gradation value of the current frame is Dx1 and a gradation value of the previous frame is Dy1, a gradation value Eb when the gradation value of the current frame is Dx2 and the gradation value of the previous frame is Dy1, a gradation value Ec when the gradation value of the current frame is Dx1 and the gradation value of the previous frame is Dy2, and a gradation value Ed when the gradation value of the current frame is Dx2 and the gradation value of the previous frame is Dy2 (see “READ FROM FIRST LUT” shown in FIG. 6).

Next, the processing section 33 reads four gradation values from the second LUT selected in step S113 (step S116). More specifically, the processing section 33 reads, from the second LUT, a gradation value Ee when the gradation value of the current frame is Dx1 and the gradation value of the previous frame is Dy1, a gradation value Ef when the gradation value of the current frame is Dx2 and the gradation value of the previous frame is Dy1, a gradation value Eg when the gradation value of the current frame is Dx1 and the gradation value of the previous frame is Dy2, and a gradation value Eh when the gradation value of the current frame is Dx2 and the gradation value of the previous frame is Dy2 (see “READ FROM SECOND LUT” shown in FIG. 6).

Next, the processing section 33 obtains a gradation value E1 by performing a linear interpolation operation shown in following formulae (1) to (3), on the four gradation values Ea to Ed read in step S115 (step S117, see “FIRST LINEAR INTERPOLATION OPERATION” shown in FIG. 6).

$$\begin{matrix} W 1 = Dx - Dx 1 & ( 1 ) \\ W 2 = Dy - Dy 1 & ( 2 ) \\ E 1 = \{ \begin{matrix}Ea + \frac{( Eb - Ea ) W 1}{Dx 2 - Dx 1} + \frac{( Ed - Eb ) W 2}{Dy 2 - Dy 1} & ( when W 1 \geq W 2 ) \\ Ea + \frac{( Ed - Ec ) W 1}{Dx 2 - Dx 1} + \frac{( Ec - Ea ) W 2}{Dy 2 - Dy 1} & ( when W 1 < W 2 )\end{matrix} & ( 3 )\end{matrix}$$

Next, the processing section 33 obtains a gradation value E2 by performing a linear interpolation operation shown in a following formula (4), on the four gradation values Ee to Eh read in step S116 (step S118, see “SECOND LINEAR INTERPOLATION OPERATION” shown in FIG. 6).

$$E 2 = \{ \begin{matrix}Ee + \frac{( Ef - Ee ) W 1}{Dx 2 - Dx 1} + \frac{( Eh - Ef ) W 2}{Dy 2 - Dy 1} & ( when W 1 \geq W 2 ) \\ Ee + \frac{( Eh - Eg ) W 1}{Dx 2 - Dx 1} + \frac{( Eg - Ee ) W 2}{Dy 2 - Dy 1} & ( when W 1 < W 2 )\end{matrix} \qquad ( 4 )$$

Next, the processing section 33 obtains the corrected gradation value Dz by performing a linear interpolation operation shown in a following formula (5), on the gradation value E1 obtained in step S117 and the gradation value E2 obtained in step S118 (step S119, see “THIRD LINEAR INTERPOLATION OPERATION” shown in FIG. 6).

Dz=E1+(E2−E1)(i−i1)/(i2−i1) (5)

After that, the processing section 33 ends the processing.

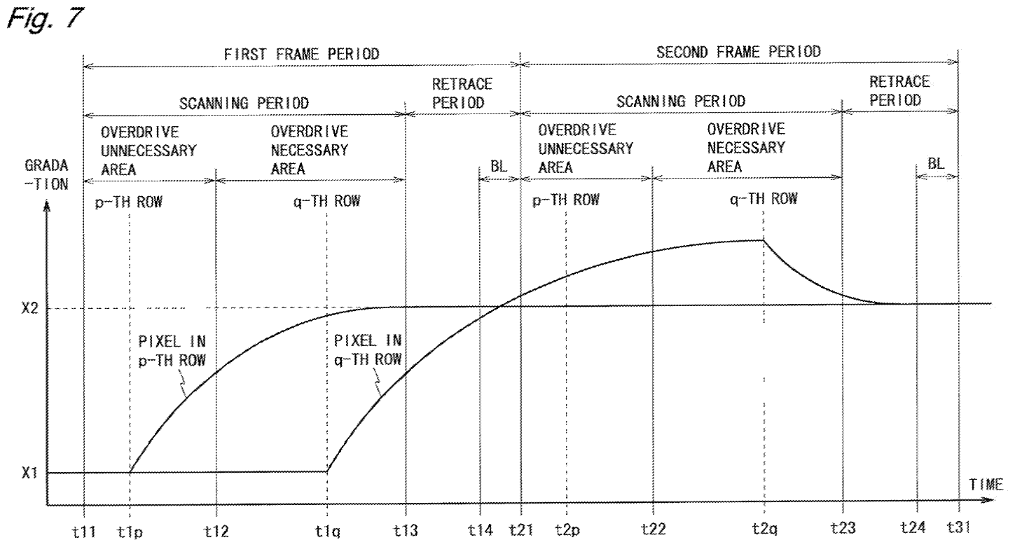

FIG. 7 is a timing chart of the liquid crystal display device 10. FIG. 7 describes a manner in which the gradation of the pixel 20p in the p-th row and the gradation of the pixel 20q in the q-th row change from X1 to X2. Since the gradation of the pixel 20 changes in a similar manner to the transmittance of the pixel 20 in the liquid crystal display device 10, the gradation of the pixel 20 in the following description may be read as the transmittance of the pixel 20.

In FIG. 7, a period from time t11 to time t21 is a first frame period, and a period from the time t21 to time t31 is a second frame period. In the first frame period, a period from the time t11 to time t13 corresponds to m horizontal periods, and a period from the time t13 to the time t21 is a retrace period. A period from the time t11 to time t12 is a write period to the pixels 20 in the overdrive unnecessary area 41, a period from the time t12 to the time t13 is a write period to the pixels 20 in the overdrive necessary area 42, and a period from time t14 to the time t21 is a backlight turn-on period. Times tip, t2p are write timings to the pixel 20p in the p-th row, and times t1q, t2q are write timings to the pixel 20q in the q-th row.

In the period from the time t11 to the time t12, the video signal V2 is written to the pixels 20 in the overdrive unnecessary area 41. The gradations of the pixels 20 in the overdrive unnecessary area 41 converge to the target levels before the backlight turn-on period, even when the video signal V2 on which the overdrive processing is not performed (input video signal V1) is written to the pixels 20. At the time tip, the data voltage based on the video signal V2 on which the overdrive processing is not performed is written to the pixel 20p in the p-th row. Even in this case, the gradation of the pixel 20p in the p-th row converges to the target level X2 before the backlight turn-on period.

In the period from the time t12 to the time t13, the corrected video signal V2 is written to the pixels 20 in the overdrive necessary area 42. The corrected video signal V2 on which the overdrive processing is performed is written to the pixels 20 in the overdrive necessary area 42. Thus, the gradation of the pixel 20 in the backlight turn-on period becomes equal to the target level. X2 or becomes a level close to the target level X2. At the time t1q, the data voltage based on the corrected video signal V2 on which the overdrive processing is performed is written to the pixel 20q in the q-th row. With this, brightness of the pixel 20q in the q-th row becomes equal to the target level X2 or becomes the level close to the target level X2 in the backlight turn-on period.

In this manner, in the liquid crystal display device 10, the gradation of the pixel 20 in the overdrive unnecessary area 41 and the gradation of the pixel 20 in the overdrive necessary area 42 become equal to the target level X2 or become the level close to the target level X2 in the backlight turn-on period. In the liquid crystal display device 10, the previous frame memory 32 storing the input video signal V1 of less than one frame is used, and the video signal with respect to the pixels 20 in the overdrive unnecessary area 41 is not stored in the previous frame memory 32. Furthermore, even if the input video signal V1 is not corrected, the gradations of the pixels 20 in the overdrive unnecessary area 41 converge to the target levels before the backlight turn-on period. Therefore, according to the liquid crystal display device 10, a capacity of a frame memory storing the video signal of the previous frame can be reduced without deteriorating an image quality of a display image.

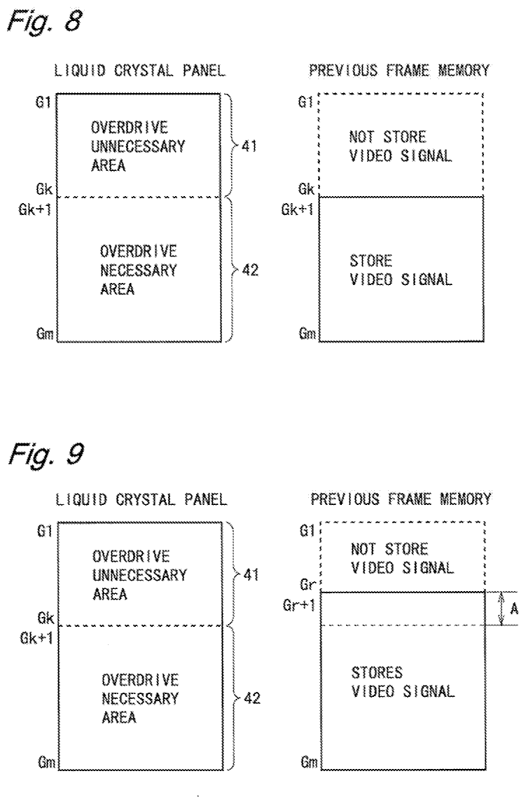

As for the liquid crystal display device 10 according to the present embodiment, various kinds of modifications can be configured. In the liquid crystal display device 10, the overdrive unnecessary area 41 is equal to a range in which the previous frame memory 32 does not store the input video signal V1, and the overdrive necessary area 42 is equal to a range in which the previous frame memory 32 stores the input video signal V1 (see FIG. 8). In a liquid crystal display device according to a modification, the previous frame memory may store the input video signal with respect to a part (part A in FIG. 9) of the pixels in the overdrive unnecessary area 41 in addition to the input video signal corresponding to the overdrive necessary area 42. If the previous frame memory does not store the video signal with respect to the pixels in the first to r-th rows and stores the video signal with respect to the pixels in the (r+1)-th to m-th rows, it is required that r<k be satisfied in the liquid crystal display device according to the modification. In this case, the processing section 33 may perform the overdrive processing on the input video signal with respect to a part of the pixels in the overdrive unnecessary area 41, and does not necessarily perform the overdrive processing thereon. Furthermore, in a liquid crystal display device according to another modification, the previous frame memory 32 may store the corrected video signal V2 in place of the input video signal V1.

Furthermore, the number M of the LUTs 34 may be an arbitrary integer not smaller than 2 and not larger than (m−k). When M=(m−k) is satisfied, the processing section 33 obtains the corrected gradation value Dz based on the gradation values read from one LUT 34. In this case, the processing section 33 does not perform the linear interpolation operation in step S119. Furthermore, the number N of the representative gradation values included in the LUT 34 may be an arbitrary integer not smaller than 2 and not larger than the maximum gradation value. When N is equal to the maximum gradation value, the processing section 33 does not perform the linear interpolation operations in steps S117, S118. Furthermore, the processing section 33 may perform an interpolation operation other than the linear interpolation operation when obtaining the corrected gradation value Dz. Furthermore, the overdrive processing circuit 30 may include a plurality of LUTs 34 in accordance with a temperature. In this case, the processing section 33 may switch the selected LUT 34 in accordance with an operation temperature, or may select two sets of the LUTs 34 based on the operation temperature and obtain the corrected gradation value by performing a linear interpolation operation on the gradation values read from the selected two sets of the LUTs.

As described above, the liquid crystal display device according to the present embodiment and the modifications includes the liquid crystal panel 11 including the pixels 20, the backlight 16, and the overdrive processing circuit 30 for obtaining the corrected video signal V2 by performing, on the input video signal V1, a correction (overdrive processing) for emphasizing a temporal change of a gradation, a panel drive circuit (scanning line drive circuit 13 and data line drive circuit 14) for writing the corrected video signal V2 to the pixels 20 in a predetermined order, and the backlight drive circuit 15 for controlling the backlight 16 to turn on in the backlight turn-on period in one frame period. The liquid crystal panel 11 has the overdrive unnecessary area 41 including the pixels 20 of which gradations converge to the target levels before the backlight turn-on period when an arbitrary video signal is written to the pixels, and the overdrive necessary area 42 including the remaining pixels 20. The overdrive processing circuit 30 includes the previous frame memory 32 for storing the input video signal of less than one frame, including the input video signal with respect to the pixels 20 in the overdrive necessary area 42, and the processing section 33 for performing the correction at least on the input video signal with respect to the pixels 20 in the overdrive necessary area 42.

In such a liquid crystal display device, the previous frame memory 32 for storing the input video signal of less than one frame is used, and the input video signal with respect to at least a part of the pixels in the overdrive unnecessary area 41 is not stored in the previous frame memory 32. Furthermore, even if the input video signal V1 is not corrected, the gradations of the pixels 20 in the overdrive unnecessary area 41 converge to the target levels before the backlight turn-on period. Therefore, in the liquid crystal display device performing the overdrive drive and the impulse drive, a capacity of a frame memory storing the video signal of the previous frame can be reduced without deteriorating an image quality of a display image.

The overdrive processing circuit 30 performs, on the input video signal V1 with respect to the pixels 20 in the overdrive necessary area 42, the correction for bringing the gradations of the pixels 20 to the target levels in the backlight turn-on period when the corrected video signal V2 it written to the pixels 20. The overdrive processing circuit 30 performs the correction for further emphasizing the temporal change of the gradation, as the time from writing to the pixel 20 to the backlight turn-on period is shorter. With this, it is possible to make the gradations of the pixels 20 in the overdrive necessary area 42 equal to the target levels or levels close to the target levels in the backlight turn-on period.

The overdrive processing circuit 30 includes the plurality of LUTs 34, and the processing section 33 performs the correction by selecting two LUTs from the plurality of LUTs 34 in accordance with the time, obtaining two gradation values using the two LUTs, and performing an interpolation operation on the two gradation values. With this, the number of the LUTs 34 included in the overdrive processing circuit 30 can be reduced. The LUT 34 stores the gradation values corresponding to combinations of the representative gradation values of the video signal of the current frame and the representative gradation values of the video signal of the previous frame, and when obtaining the gradation value using the LUT 34, the processing section 33 reads from the LUT 34 a plurality of gradation values in accordance with the gradation value of the current frame included in the input video signal V1 and the gradation value included in the video signal of the previous frame stored in the previous frame memory 32, and performs an interpolation operation on the plurality of gradation values. With this, a size of the LUT 34 included in the overdrive processing circuit 30 can be reduced.

The previous frame memory 32 may store only the input video signal V1 with respect to the pixels 20 in the overdrive necessary area 42. With this, a capacity of the previous frame memory 32 can be minimized. Alternatively, the previous frame memory 32 may store the input video signal V1 with respect to the pixels 20 in the overdrive necessary area 42 and in a part of the pixels 20 in the overdrive unnecessary area 41. With this, the previous frame memory 32 having a suitable capacity in accordance with a configuration of the overdrive processing circuit 30 can be used. In this case, the processing section 33 may perform the correction only on the input video signal V1 with respect to the pixels 20 in the overdrive necessary area 42, or may perform the correction on the input video signal V1 with respect to the pixels in the overdrive necessary area 42 and a part of the pixels in the overdrive unnecessary area 41. Furthermore, the overdrive processing circuit 30 may include the current frame memory 31 for storing the input video signal V1. With this, the input video signal V can be supplied to the overdrive processing circuit 30 at a suitable timing.

According to the above-described liquid crystal display device and the drive method for same, in the liquid crystal display device performing the overdrive drive of the liquid crystal panel the impulse drive of the backlight, the capacity of the frame memory for storing the video signal of the previous frame can be reduced without deteriorating the image quality of the display image.

Although the present invention is described in detail in the above, the above description is exemplary in all of the aspects and is not restrictive. It is understood that various other changes and modification can be derived without going out of the present invention.

What is claimed is:

1. A liquid crystal display device comprising:
a liquid crystal panel including pixels;
a backlight;
an overdrive processing circuit configured to obtain a corrected video signal by performing, on an input video signal, a correction for emphasizing a temporal change of a gradation;
a panel drive circuit configured to write the corrected video signal to the pixels in a predetermined order; and
a backlight drive circuit configured to control the backlight to turn on in a backlight turn-on period in one frame period, wherein
the liquid crystal panel has an overdrive unnecessary area including the pixels of which gradations converge to target levels before the backlight turn-on period when an arbitrary video signal is written to the pixels, and an overdrive necessary area including remaining pixels, and
the overdrive processing circuit includes:
a previous frame memory configured to store the input video signal of less than one frame, including the input video signal with respect to the pixels in the overdrive necessary area; and
a processing section configured to perform the correction at least on the input video signal with respect to the pixels in the overdrive necessary area.

2. The liquid crystal display device according to claim 1, wherein the overdrive processing circuit is configured to perform, on the input video signal with respect to the pixels in the overdrive necessary area, the correction for bringing the gradations of the pixels to the target levels in the backlight turn-on period when the corrected video signal is written to the pixels.

3. The liquid crystal display device according to claim 2, wherein the overdrive processing circuit is configured to perform the correction for further emphasizing the temporal change of the gradation, as time from writing to the pixel to the backlight turn-on period is shorter.

4. The liquid crystal display device according to claim 3, wherein
the overdrive processing circuit includes a plurality of look-up tables, and
the processing section is configured to perform the correction by selecting two look-up tables from the plurality of look-up tables in accordance with the time, obtaining two gradation values using the two look-up tables, and performing an interpolation operation on the two gradation values.

5. The liquid crystal display device according to claim 4, wherein
the look-up table is configured to store gradation values corresponding to combinations of representative gradation values of a video signal of a current frame and representative gradation values of a video signal of a previous frame, and
the processing section is configured to, when obtaining the gradation value using the look-up table, read from the look-up table a plurality of gradation values in accordance with a gradation value of a current frame included in the input video signal and a gradation value of a previous frame included in the video signal stored in the previous frame memory, and perform an interpolation operation on the plurality of gradation values.

6. The liquid crystal display device according to claim 2, wherein the previous frame memory is configured to store only the input video signal with respect to the pixels in the overdrive necessary area.

7. The liquid crystal display device according to claim 2, wherein the previous frame memory is configured to store the input video signal with respect to the pixels in the overdrive necessary area and a part of the pixels in the overdrive unnecessary area.

8. The liquid crystal display device according to claim 7, wherein the processing section is configured to perform the correction only on the input video signal with respect to the pixels in the overdrive necessary area.

9. The liquid crystal display device according to claim 7, wherein the processing section is configured to perform the correction on the input video signal with respect to the pixels in the overdrive necessary area and a part of the pixels in the overdrive unnecessary area.

10. The liquid crystal display device according to claim 2, wherein the overdrive processing circuit further includes a current frame memory configured to store the input video signal.

11. A drive method of a liquid crystal display device having a liquid crystal panel including pixels and a backlight, the method comprising:
obtaining a corrected video signal in an overdrive processing circuit by performing, on an input video signal, a correction for emphasizing a temporal change of a gradation;
writing the corrected video signal to the pixels in a predetermined order; and
controlling the backlight to turn on in a backlight turn-on period in one frame period, wherein
the liquid crystal panel has an overdrive unnecessary area including the pixels of which gradations converge to target levels before the backlight turn-on period when an arbitrary video signal is written to the pixels, and an overdrive necessary area including remaining pixels,
the overdrive processing circuit includes a previous frame memory that stores the input video signal of less than one frame, including the input video signal with respect to the pixels in the overdrive necessary area, and
in obtaining the corrected video signal, the correction is performed at least on the input video signal with respect to the pixels in the overdrive necessary area.
